(19) United States
(12) Patent Application Publication
(10) Pub. No.: US 2010/0054641 A1
(43) Pub. Date: Mar. 4, 2010

(54) ACTUATOR MOUNT ASSEMBLY

(75) Inventor: Scott Snow, Commerce, MI (US)

Correspondence Address: GIFFORD, KRASS, SPRINKLE,ANDERSON & CITKOWSKI, P.C, PO BOX 7021, TROY, MI, 48007-7021, US

(73) Assignee: Marine 1, LLC, New Baltimore, MI (US)

(21) Appl. No.: 12/554,079

(22) Filed: Sep. 4, 2009

Related U.S. Application Data
(60) Provisional application No. 61/094,143, filed on Sep. 4, 2008.

(51) Int. Cl. F16C 35/02; F16C 33/02

(52) U.S. Cl. 384/125; 384/428

(57) ABSTRACT

An actuator mounting assembly includes an actuator and a bearing removably attached to the actuator. A bearing plate includes a hole formed therein for receiving the bearing. A bearing mounting plate includes a hole formed therein for receiving the bearing. First and second bearing inserts are removably disposed about the holes formed in the bearing plate and bearing mounting plate. The bearing mounting plate and bearing plate are coupled to retain the bearing and bearing inserts therebetween firming a seal wherein the actuator is angularly movable about the bearing.

### CROSS-REFERENCE TO RELATED APPLICATIONS

This application claims priority of U.S. Provisional Application No. 61/094,143 filed Sep. 4, 2008 which is incorporated herein by reference.

### FIELD OF THE INVENTION

The invention relates to actuators.

### BACKGROUND OF THE INVENTION

Actuators may be utilized in various environments that require a sealing from an outside environment. For example, actuators may be used in a liquid environment. In such application it is desirable to prevent contact of the liquid with various components of the actuator to protect the components of the actuator or prevent contamination of a liquid. Various sealing agents may be used to seal an actuator assembly. However such sealing agents make servicing or repairing the actuators a costly and complicated procedure. Additionally, sealed actuators may be complicated to assemble and manufacture. There is therefore a need in the art for an actuator that may be used in a sealed application that is easy to repair and assemble. There is also a need in the art for a sealed actuator that may accommodate various angular positions.

### SUMMARY OF THE INVENTION

In one aspect, there is disclosed, an actuator mounting assembly that includes an actuator and a bearing removably attached to the actuator. A bearing plate includes a hole formed therein for receiving the bearing. A bearing mounting plate includes a hole formed therein for receiving the bearing. First and second bearing inserts are removably disposed about the holes formed in the bearing plate and bearing mounting plate. The bearing mounting plate and bearing plate are coupled to retain the bearing and bearing inserts therebetween wherein the actuator is angularly movable about the bearing.

In another aspect there is disclosed, an actuator mounting assembly that includes an actuator and a bearing removably attached to the actuator. A bearing plate includes a hole formed therein for receiving the bearing. A bearing mounting plate includes a hole formed therein for receiving the bearing. First and second bearing inserts are removably disposed about the holes formed in the bearing plate and bearing mounting plate. The bearing mounting plate and bearing plate are coupled to retain the bearing and bearing inserts therebetween forming a seal wherein the actuator is angularly movable about the bearing.

In a further aspect there is disclosed, an actuator mounting assembly that includes a device to be actuated. An actuator is connected to the device. A bearing is removably attached to the actuator. A bearing plate includes a hole formed therein for receiving the bearing. A bearing mounting plate includes a hole formed therein for receiving the bearing. First and second bearing inserts are removably disposed about the holes formed in the bearing plate and bearing mounting plate. The bearing mounting plate and bearing plate are coupled to retain the bearing and bearing inserts therebetween wherein the actuator is angularly movable about the bearing accommodating misalignment of the device.

### BRIEF DESCRIPTION OF THE DRAWINGS

FIG. 1 is an exploded perspective view of an actuator mounting assembly;

FIG. 2A, B are views of a bearing plate;

FIG. 3 is a perspective view of a bearing insert;

FIGS. 4A, B are views of a bearing;

FIG. 5A, B are views of a bearing mounting plate;

FIG. 6 is a view of one embodiment of an actuator;

FIG. 7 is a perspective view of a bearing mounting plate positioned on an inside surface of a boat hull;

FIG. 8 is a perspective view of the actuator mounting assembly;

FIG. 9 is a perspective view of the actuator mounting assembly attached on an inside of a boat hull;

FIG. 10 is a perspective view of an actuator assembly penetrating an outside of a boat hull and a trim tab to be coupled to the actuator assembly.

### DETAILED DESCRIPTION OF THE PREFERRED EMBODIMENTS

Referring to the various figures, there is shown an actuator mounting assembly 12 that includes an actuator 14. A bearing 16 is removably attached to the actuator 14. A bearing plate 18 having a hole 20 formed therein receives the bearing 16. A bearing mounting plate 22 also including a hole 24 formed therein receives the bearing 16. First and second bearing inserts 26, 28 are removably disposed about the holes 20, 24 formed in the bearing plate 18 and the bearing mounting plate 22. The bearing mounting plate 22 and bearing plate 18 are coupled together to retain the bearing 16 and bearing inserts 26, 28 between the two components. The actuator 14 is angularly movable about the bearing 16.

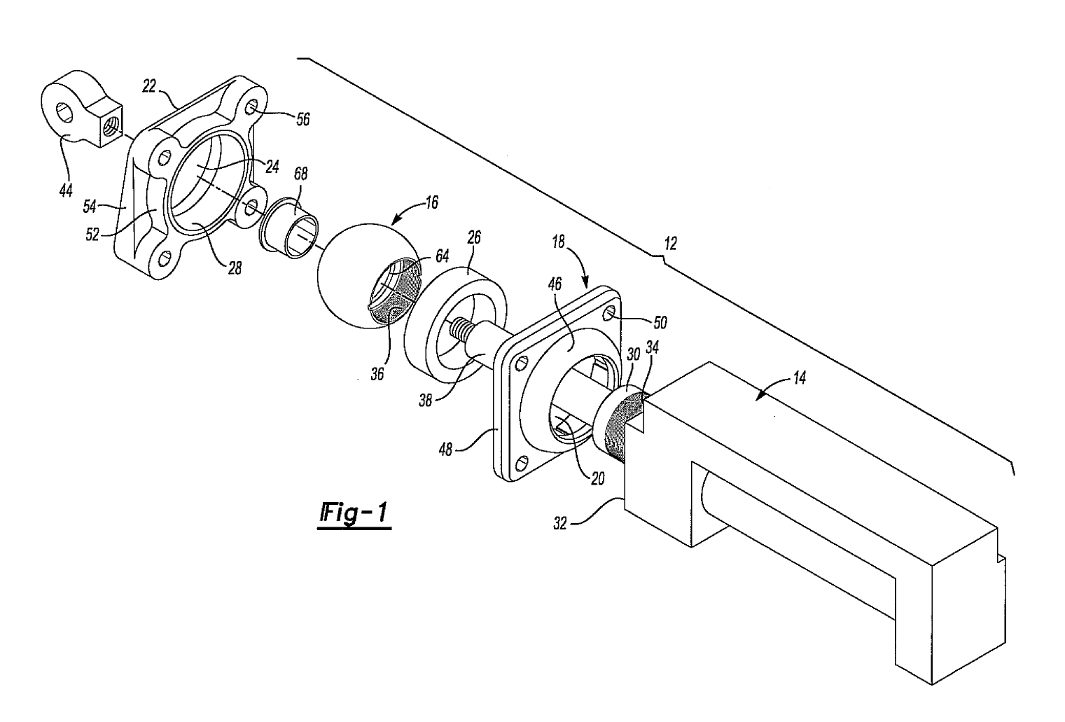

Referring to FIG. 1, there is shown a perspective view of one embodiment of an actuator mounting assembly 12. As can be seen in the figure, there is included an actuator 14. The actuator 14 in one aspect may be a linear actuator including electric, pneumatic and hydraulic cylinders as well as other linear actuators including direct driven and indirect driven linear actuators. In one aspect, the actuator 14 includes a connection portion 30 formed on a longitudinal end 32 of the actuator 14. The connection portion 30 as depicted in FIG. 1 includes threads 34 formed thereon that mate with corresponding threads 36 on the bearing 16. However, it should be understood that various structures including bayonet-type designs as well as other removable connections may be formed on the connection portion 30 with a corresponding structure formed on the bearing 16. In this manner, the bearing 16 is removably connected to the connection portion 30 of the actuator 14. Additionally, a screw or bolt may also extend through the bearing 16 into the connection portion to removably fix the bearing 16 relative to the connection portion 30.

The actuator 14 also includes a rod 38 that extends through the connection portion 30. The rod 38 is movable in and out relative to the actuator 14. A terminal end of the rod 38 may include a male threaded portion that connects with a connector 44 that is coupled to the end of the rod 38 for connecting to a device to be actuated. In one aspect, the connector 44 may be fixed relative to the rod 38.

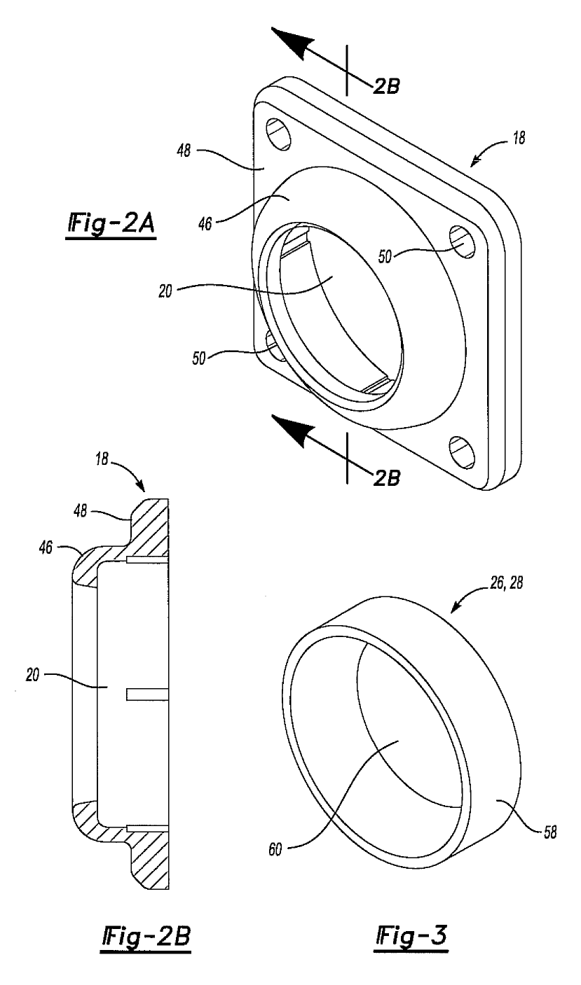

Referring to FIGS. 1 and 2A, B, there is shown a bearing plate 18 including a hole 20 formed therein that receives the bearing 16. The bearing plate 18 includes a seat 46 formed therein that is sized to receive the first bearing insert 26. The seat 46 extends to a flange 48. The flange 48 includes holes 50 formed about a periphery for connection with the bearing mounting plate 22.

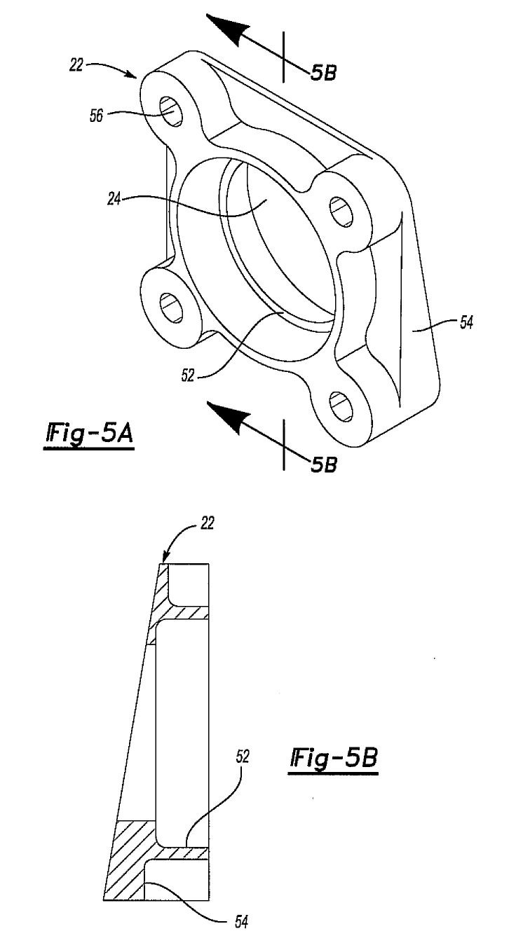

Referring to FIGS. 5A, B, there is shown a bearing mounting plate 22. As with the previously described bearing plate 18, the bearing mounting plate 22 includes a seat 52 that extends to a flange 54. As previously described above, the flange 54 may include holes 56 formed therethrough for coupling the bearing mounting plate 22 and bearing plate 18. The seat 52 of the bearing mounting plate 22 is sized to receive the second bearing insert 28 and position it about the hole 24 formed in the bearing mounting plate 22.

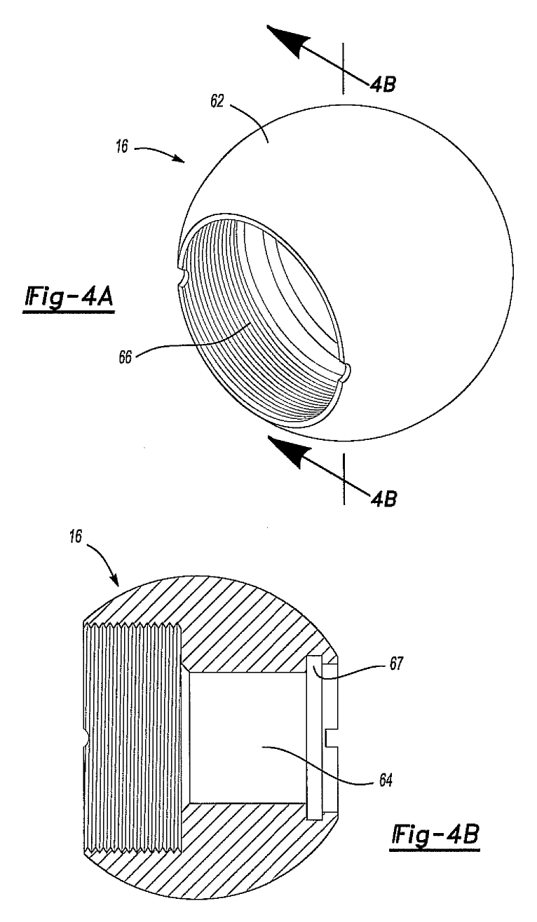

Referring to FIGS. 1 and 3, there is shown one embodiment of a bearing insert 26, 28. The depicted embodiment may represent the first and second bearing inserts 26, 28 that are removably disposed about the holes 20, 24 formed in the bearing plate 18 and bearing mounting plate 22. As can be seen in the figures, the first and second bearing inserts 26, 28 have a generally ring-like structure. The outer surface 58 of the ring is positioned to contact the walls of the seats 46, 52 defined in the bearing plate 18 and bearing mounting plate 22. The inner surface 60 of the bearing inserts 26, 28 contacts the bearing 16 when installed. The inner surface 60 of the bearing inserts 26, 28 provides a contact surface with the bearing 16 to allow for smooth movement of the bearing 16. In one aspect, the bearing inserts 26, 28 are prefabricated and may be formed of various bearing materials including Kynar, UHMW polyethylene, ceramics or other suitable bearing materials. In another aspect, the first and second bearing inserts 26, 28 may be formed of different materials. For example, the first bearing insert 26 may be formed of a high strength material capable of absorbing high loads applied to the bearing 16. The second bearing insert 28 may be formed of a more elastic material to provide an increased sealing property relative to the bearing 16.

Referring to FIGS. 1 and 4A, B, there is shown a bearing 16 of the actuator mounting assembly 12. The bearing 16 in one aspect may include a spherical body 62 having a bore 64 formed therein. In one aspect, the bore 64 may include a threaded portion 66 that mates with the threads formed on the connection portion 30 of the actuator 14. The bore 64 may also include a counter bore 67 that defines a retaining slot having a wiper ring 68 disposed therein. The wiper ring 68 seals relative to the rod 38 of the actuator 14 preventing ingress of a fluid about the rod 38.

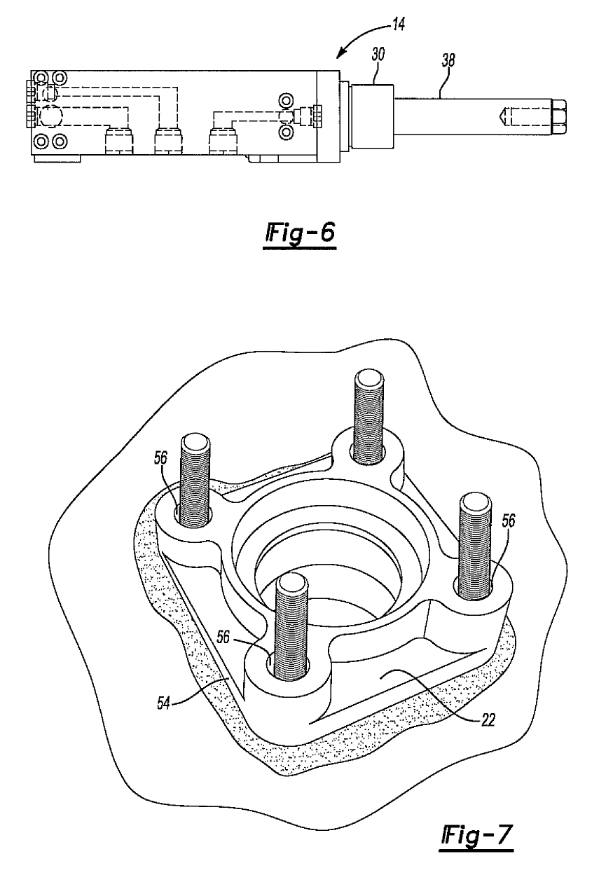

Referring to FIG. 6, there is shown one actuator 14 that may be utilized. As described above, various linear actuators may be utilized. However the depicted embodiment of FIG. 6 includes a hydraulic cylinder including the connection portion 30 and rod 38 as described above.

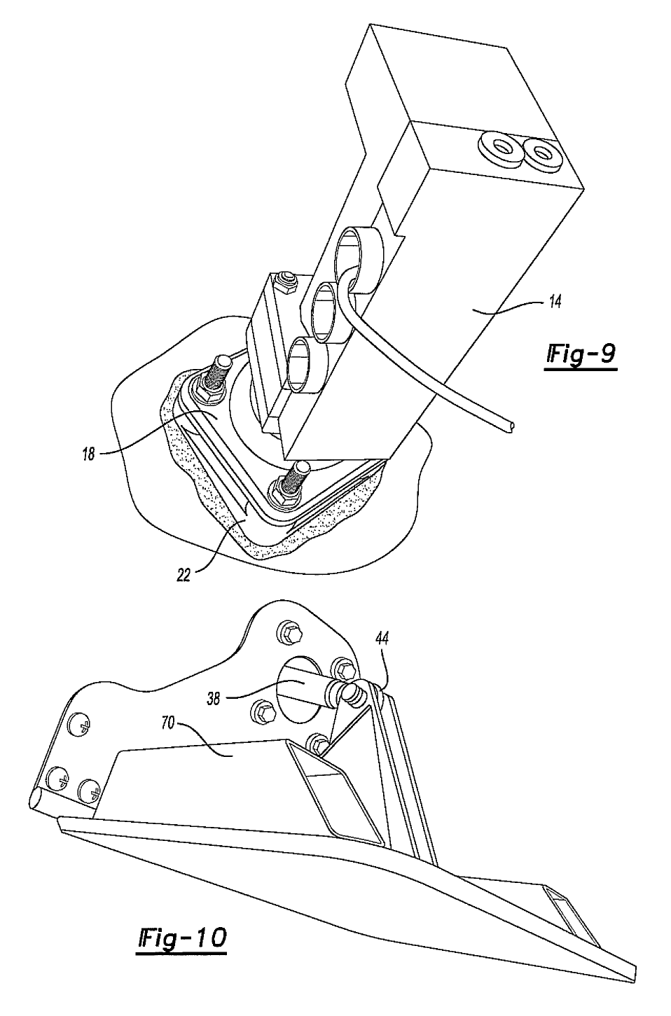

Again referring to FIGS. 1 and 5A, B, the actuator mounting assembly 12 may be assembled such that the bearing plate 18 is positioned about the actuator rod 38 and connection portion 30 of the actuator 14. The first bearing insert 26 may be positioned within the seat 46 formed in the bearing plate 18. The bearing 16 may then be positioned in the first bearing insert 26 and threadably attached to the connection portion 30. The wiper ring 68 may be positioned within the counter bore 67 formed in the bearing 16. The second bearing insert 28 may be positioned in the seat 52 defined in the bearing mounting plate 22. The bearing mounting plate 22 may then be positioned about the bearing 16. The bearing plate 18 and the bearing mounting plate 22 may then be coupled using appropriate fasteners such as bolts and nuts as shown in FIGS. 7 and 9. In this manner the bearing 16 is sealed by the first and second bearing inserts 26, 28 to preventingress of fluid to the actuator 14. Additionally, the reverse operation may be easily performed such that the bearing 16 or bearing inserts 26, 28 may be inspected and replaced as necessary. The removable nature of the bearing 16 and bearing inserts 26, 28 provides an improved design allowing simplified assembly and disassembly of the actuator mounting assembly 12.

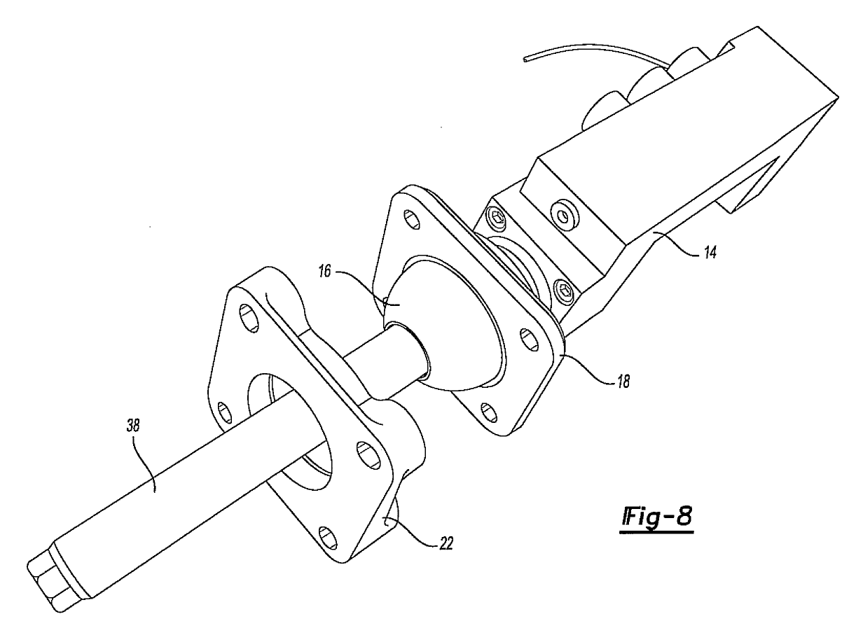

Referring to FIGS. 7-10, there is shown the actuator mounting assembly 12 installed on a hull of a boat. As can be seen in FIG. 7, the bearing mounting plate 22 is positioned relative to an inside surface of a vessel. Bolts extending from an outside surface of the vessel are positioned in the holes 56 formed in the flange 54 of the bearing mounting plate 22. The actuator mounting assembly 12 may be assembled as previously described above such that the bearing 16 is attached to the connection portion 30 of the actuator 14 and the first and second bearing inserts 26, 28 are positioned within the bearing plate 18 and bearing mounting plate 22 with the bolts passing through the holes 50 on the flange 48 of the bearing plate 18 with a nut tightened about the bolts to couple the bearing plate 18 and bearing mounting plate 22 thereby sealing the bearing 16 relative to the actuator 14. In this manner, the rod 38 of the actuator 14 may pass through the bearing 16 and bearing mounting plates 18, 22 and extend to an exterior of the vessel or boat as shown in FIG. 10. The first and second bearing inserts 26, 28 mate with the bearing 16 prevent egress of fluid such as water into the inside of the boat hull.

As shown in FIG. 10, the rod 38 may be coupled to a trim tab 70 to allow for actuation of the trim tab 70. In this manner, the actuator 14 may be moveable angularly about the bearing 16 to accommodate misalignments or variations of the trim tab 70. In another aspect, and as shown in FIGS. 1 and 10, the connector 44 may be fixed and coupled to an end of the rod 38 and connects to the trim tab 70. In this manner, a movable joint or other such connection that may be prone to failure is eliminated. The actuator 14 is free to displace angularly thereby eliminating the need for a movable joint.

While an example has been described with a boat hull, it should be realized that the actuator mounting assembly 12 may be utilized in many applications requiring an actuator that accommodates misalignment with an actuated device. Additionally, various other implementations requiring a sealing of an actuator relative to an exterior environment such as in a high corrosion environment or other clean room type environment may also utilize the actuator mounting assembly 12.

1. An actuator mounting assembly comprising:
an actuator;
a bearing removably attached to the actuator;
a bearing plate including a hole formed therein for receiving the bearing;
a bearing mounting plate including a hole formed therein for receiving the bearing;
first and second bearing inserts removably disposed about the holes formed in the bearing plate and bearing mounting plate;
wherein the bearing mounting plate and bearing plate are coupled to retain the bearing and bearing inserts therebetween wherein the actuator is angularly movable.

2. The actuator mounting assembly of claim 1 wherein the actuator is sealed.

3. The actuator mounting assembly of claim 1 wherein the bearing includes a spherical body having a bore formed therein.

4. The actuator mounting assembly of claim 3 wherein the bore includes a threaded portion that mates with threads formed on a connection portion of the actuator and the bore further including a counter bore defining a retaining slot having a wiper ring disposed therein.

5. The actuator mounting assembly of claim 4 wherein the actuator is a linear actuator.

6. The actuator mounting assembly of claim 5 wherein the actuator includes a rod extending through the connection portion, bearing plate, bearing, first and second bearing inserts and bearing mounting plate and is movable in and out relative to the actuator.

7. The actuator mounting assembly of claim 6 including a connector coupled to an end of the rod for connecting to a device to be actuated.

8. The actuator mounting assembly of claim 7 wherein the connect is fixed relative to the rod.

9. The actuator mounting assembly of claim 1 wherein the bearing mounting plate includes holes formed therethrough about a periphery of the plate corresponding to holes formed about a periphery of the bearing plate and fasteners inserted into the holes coupling the bearing mounting plate and bearing plate.

10. The actuator mounting assembly of claim 1 wherein the first and second bearing inserts are formed of the same material.

11. The actuator mounting assembly of claim 1 wherein the first and second bearing inserts are formed of different materials.

12. The actuator mounting assembly of claim 11 wherein the first bearing insert is formed of a high strength material capable of absorbing high loads.

13. The actuator mounting assembly of claim 11 wherein the second bearing insert is formed of an elastic material enhancing a sealing relative to the bearing.

14. An actuator mounting assembly comprising:
an actuator;
a bearing removably attached to the actuator;
a bearing plate including a hole formed therein for receiving the bearing;
a bearing mounting plate including a hole formed therein for receiving the bearing;
first and second bearing inserts removably disposed about the holes formed in the bearing plate and bearing mounting plate;
wherein the bearing mounting plate and bearing plate are coupled to retain the bearing and bearing inserts therebetween forming a seal wherein the actuator is angularly movable.

15. An actuator mounting assembly comprising:
a device to be actuated;
an actuator connected to the device; a bearing removably attached to the actuator;
a bearing plate including a hole formed therein for receiving the bearing;
a bearing mounting plate including a hole formed therein for receiving the bearing;
first and second bearing inserts removably disposed about the holes formed in the bearing plate and bearing mounting plate;
wherein the bearing mounting plate and bearing plate are coupled to retain the bearing and bearing inserts therebetween wherein the actuator is angularly movable accommodating misalignment of the device.
